(19) United States
(12) Patent Application Publication
(10) Pub. No.: US 2014/0049821 A1
(43) Pub. Date: Feb. 20, 2014

(54) DRIVING METHOD OF 3D SHUTTER TYPE GLASSES AND DRIVING CIRCUIT THEREOF

(71) Applicants: Liangchan Liao, Shenzhen (CN); Yuyeh Chen, Shenzhen (CN)

(72) Inventors: Liangchan Liao, Shenzhen (CN); Yuyeh Chen, Shenzhen (CN)

(73) Assignee: SHENZHEN CHINA STAR OPTOELECTRONICS TECHNOLOGY CO., LTD., Shenzhen, Guangdong 518132 (CN)

(21) Appl. No.: 13/643,100

(22) PCT Filed: Sep. 28, 2012
(86) PCT No.: PCT/CN2012/082259

§ 371 Date: Oct. 24, 2012

(30) Foreign Application Priority Data
Aug. 14, 2012 (CN) 201210288568.9

(51) Int. Cl. G02B 27/22

(52) U.S. Cl. CPC G02B 27/2264
USPC 359/464

(57) ABSTRACT

The present disclosure discloses a driving method of three-dimensional (3D) shutter type glasses and a driving circuit thereof. In a driving method of the 3D shutter type glasses, a left lens is transparent in its transparent cycles and dosed in its shutdown cycles, and a right lens is transparent in its transparent cycles and closed in its shutdown cycles the driving circuit of the 3D shutter type glasses executes a step of at least outputting a section of low-level signals in one transparent cycle of each lens. The present disclosure can effectively improve the flash of the 3D shutter type glasses.

### TECHNICAL FIELD

The present disclosure relates to the field of liquid crystal displays (LCD), and more particularly to a driving method of three-dimensional (3D) shutter type glasses and a driving circuit thereof.

### BACKGROUND

To a flash three-dimensional (3D) image on a liquid crystal display (LCD), display signals including a left eye image and a right eye image are alternately displayed. An observer needs to wear a pair of shutter type glasses where lenses of the glasses include LCs (liquid crystals). Deflection of LC molecules is controlled through a driving circuit of the 3D shutter type glasses, thus realizing conduction and termination of light rays of the lenses. When the LCD displays the left eye image, the driving circuit outputs a high-level signal to drive the conduction of the left lens and ending the conduction of the right lens. In this way, the left eye of the observer can see the left eye image and the right eye of the observer may not see the image of the left eye image, and vice versa. By the alternately rotating between the left eye image and the right eye image, a three-dimensional pattern is synthesized in a brain of the observer to form a 3D display effect.

As shown in FIG. 1, taking one lens as an example, dotted line b is a control waveform of the driving circuit, and curve a is a luminous flux waveform diagram of the lens in a first transparent cycle, the driving circuit, outputs one persistent high-level signal. Because the deflection of the LC molecules needs some time, luminous flux presents a gradual increase process. After the first transparent cycle ends, the driving circuit outputs one persistent shutdown level signal. The lens enters a shutdown cycle. Similarly, because of the delayed effect of the LC molecules, the luminous flux presents a gradual decrease process until the end. When a second transparent cycle arrives, the driving circuit outputs one high-level signal which is inverse with the first transparent cycle. Correspondingly, the LC molecules deflect inversely. Similarly, the luminous flux performs a gradual increase process and then a gradual decrease process until the end, in this way, one lens outputs two persistent high-level signals in opposite directions in two adjacent transparent cycles. Intermediate voltage between two adjacent transparent cycles is not changed or interrupted. In the shutter type glasses of the prior art, the twinkle is generated in the observation process of human eyes and the viewing experience is influenced.

### SUMMARY

In view of the above-described problems, the aim of the present disclosure is to provide a driving method of three-dimensional (3D) shutter type glasses and a driving circuit thereof for improving the twinkle problem of the 3D shutter type glasses.

The purpose of the present disclosure is achieved by the following technical scheme:

In a driving method of 3D shutter type glasses, a left lens of the 3D shutter type glasses is transparent in its transparent cycles and closed in its shutdown cycles, and a right lens of the 3D shutter type glasses is transparent in its transparent cycles and closed in its shutdown cycles, wherein a driving circuit of the 3D shutter type glasses executes the step A: at least outputting a section of low-level signals in one transparent cycle of each lens.

In one example, the low-level signal is a shutdown level signal. The low-level signal is the shutdown signal and is easy to control. The voltage difference between the low-level signal and the high-level signal is larger. Liquid crystals (LCs) can deflect more quickly, and the regulation effect is better.

In one example, in the step A, only a section of low-level signals are outputted in one transparent cycle of each lens. In a single transparent cycle, a first high-level signal is outputted before the low-level signal is outputted. A second high-level signal is outputted after the low-level signal is outputted. The frequency of outputting the low level is higher, the light loss of a display image is more and the image is darker. If the lenses are closed once, the twinkle is reduced and the light loss is reduced to a minimum.

In one example, in the step A, a proportion of duration of the low-level signal to the transparent cycle of one lens is between 1/7 and ⅕. This is a specified closing time proportion. Because the deflection of the LCs needs some time, duration of the low-level signal may not be too short, otherwise, the LCs may not deflect. Certainly, duration may not be too long; otherwise, the loss of the luminous flux is too much, thus influencing the display effect. A study finds it is good that the proportion of the low-level signal to the transparent cycle of one lens is between 1/7 and ⅕.

In one example, in the step A, the proportion of duration of the first high-level signal before the low-level signals to the transparent cycle of one lens is between 2/7 and ⅖. After the output of the first high-level signal is finished, the LCs do not reach a required deflection position. At this moment, the low-level signal is outputted and the loss of the luminous flux is smaller.

In one example, in the step A, the proportion of duration of the second high-level signal after the low-level signal to the transparent cycle of one lens is between 2/7 and ⅖. Before the second high-level signal is outputted, the LCs almost reach the deflection position. At this moment, light rays of entering the glasses are strongest. Heretofore, the low-level signal is outputted, thus better reducing the twinkle.

In one example, in the step A, in one transparent cycle of each lens, the proportion of durations of the low-level signals to the first high-level signals to the second high-level signals is 2:1:3, in a study, by adopting the proportion of the present disclosure, contradiction between the reduction of the twinkle and the reduction of the light loss can he effectively balanced and the viewing effect can be improved.

A driving circuit of a three-dimensional (3D) shutter type glasses. The driving circuit of the 3D shutter type glasses comprises a control module for at least outputting a section of low-level signals in one transparent cycle of each lens of the 3D shutter type glasses.

In one example, a proportion of duration of the low-level signal outputted by the control module in a display cycle of one lens is between 1/7 and ⅕ in an entire display cycle of the one lens. This is a specified closing time proportion. Because the deflection of the LCs needs some time, the shutdown time may not be too short; otherwise, the LCs may not deflect. Certainly, the shutdown time may not be too long; otherwise, the light loss is too much, thus influencing the display effect. A study finds it is good that the proportion of the low-level signals to the display cycle of one lens is between 1/7 and ⅕.

In one example, the control module successively outputs a first high-level signal, the low-level signal, and a second high-level signal in the display cycle of one lens. The proportion of durations of the first high-level signal to the low-level signal to the second high-level signal is 2:1:3. In a study, by adopting the proportion of the present disclosure, contradiction between the reduction of the twinkle and the reduction of the light loss can be effectively balanced and the viewing effect can be improved.

The luminous flux waveform diagram of the lens that is based on a time axis in a single transparent cycle is transformed into a luminous flux waveform diagram of the lens that is based on a frequency waveform diagram using a Fourier transform. As shown in FIG. 2, it is known from frequency domain curve d and twinkle curve c that there is a high scintillation perception of the human eyes to the images at 60 Hz frequency and it is a main reason to cause the twinkle problem. In the present disclosure, a section of low-level signals are at least outputted in one transparent cycle of each lens. In this way, the luminous flux waveform in the present disclosure further deviates from a sine curve compared to the luminous flux waveform in the prior art at 60 Hz frequency. After applying the Fourier transform a time domain waveform of the luminous flux waveform is transformed into a frequency domain waveform of the luminous flux waveform. The part of the time domain waveform that deviates from the sine curve is fitted using a high frequency part in Fourier fitting. Due to the delayed effect of the LCs, a frequency spectrum waveform of the luminous flux curve forms more waveforms at higher frequencies. As the frequency of shutdown increases, energy distributed at higher frequency also increases, and the frequency band distributed on the waveform becomes higher. As the frequency band on the frequency spectrum becomes higher, the more difficult the generation of the twinkle by the human eyes becomes.

Therefore, the present disclosure can effectively improve the twinkle problem of the 3D shutter type glasses.

### BRIEF DESCRIPTION OF FIGURES

FIG. 1 is a schematic diagram of a driving waveform and a luminous flux waveform of typical three-dimensional (3D) shutter type glasses;

FIG. 2 is a schematic diagram of transforming a luminous flux waveform into a frequency domain waveform by Fourier transform in typical 3D shutter type glasses;

FIG. 3 a schematic diagram of backlight scan of a liquid crystal display (LCD) device;

FIG. 4 is a schematic diagram of a driving waveform and a luminous flux waveform of 3D shutter type glasses in an example of the present disclosure;

FIG. 5 is a schematic diagram of transforming a luminous flux waveform into a frequency domain waveform by Fourier transform in 3D shutter type glasses in an example of the present disclosure.

### DETAILED DESCRIPTION

The present disclosure discloses a three-dimensional (3D) liquid crystal display (LCD) system. The system comprises a 3D LCD and a set of 3D shutter type glasses. The 3D shutter type glasses comprise a left lens and a right lens. Liquid crystal (LC) molecules are filled in each lens. The glasses are internally configured with a driving circuit to control deflection of the LC molecules. The driving circuit of the 3D shutter type glasses comprises a control module to at least output a section of low-level signals in one transparent cycle of each lens.

The present disclosure also discloses a 3D shutter type glasses driving method. A left lens of the 3D shutter type glasses is transparent in its transparent cycles and closed in its shutdown cycles, and a right lens of the 3D shutter type glasses is transparent in its transparent cycles and closed in its shutdown cycles. The driving circuit of the 3D shutter type glasses executes step A: at least outputting a section of low-level signals in one transparent cycle of each lens.

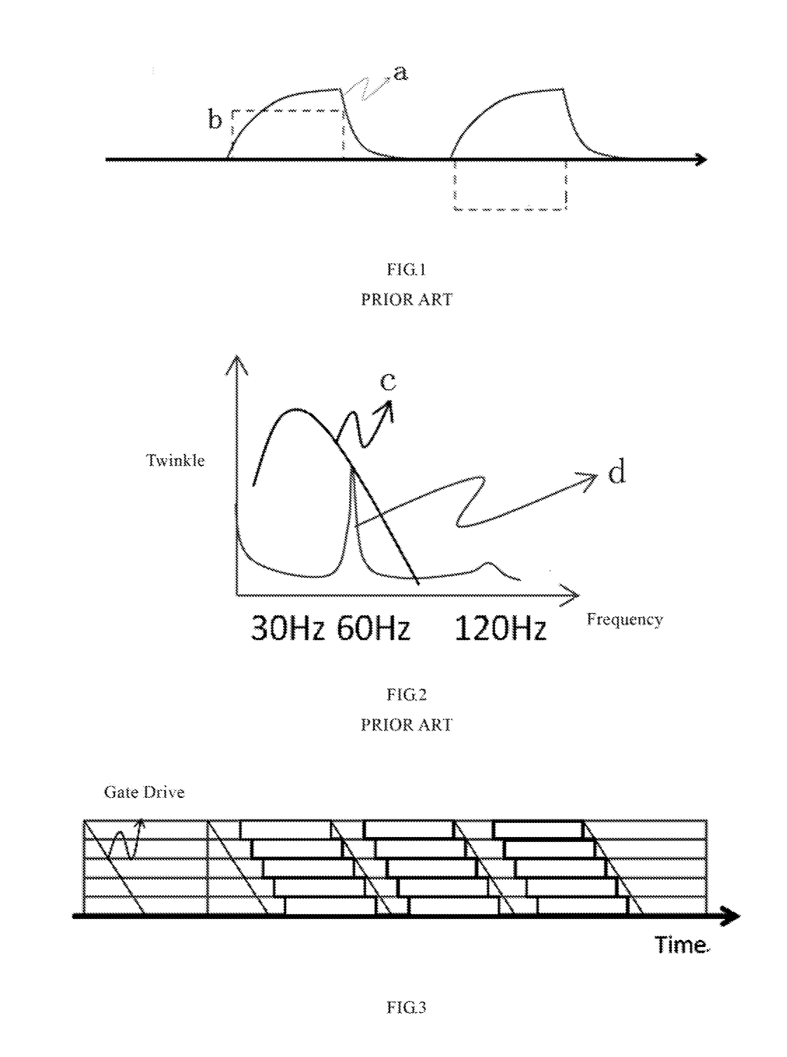

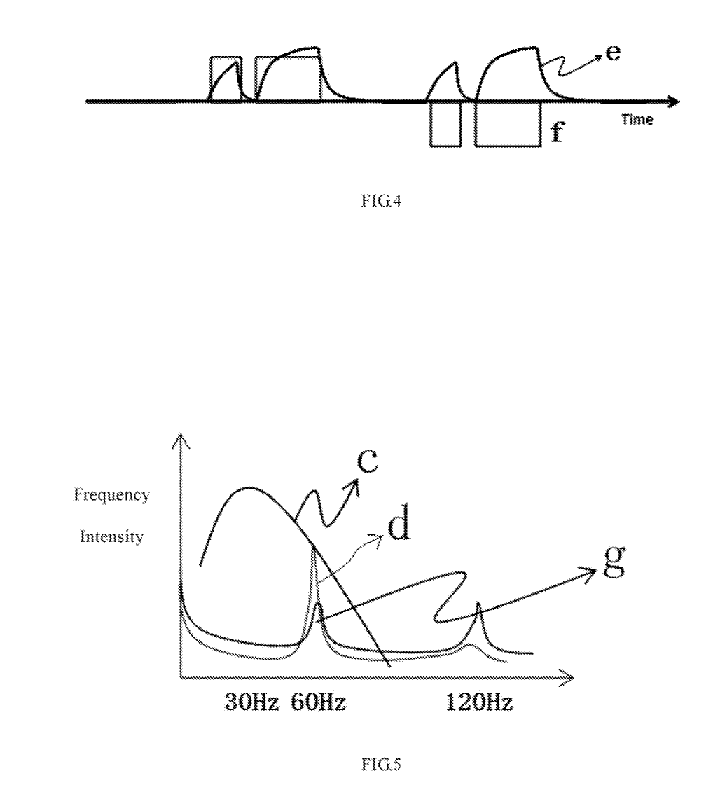

A luminous flux waveform diagram of the lens that is based on a time axis in a single transparent cycle is transformed into a luminous flux waveform diagram of the lens that is based on a frequency waveform diagram using a Fourier transform by the inventor. As shown in FIG. 2, it is known from frequency domain curve d and twinkle curve c that there is a high scintillation perception of the human eyes to the images at 60 Hz frequency and it is a main reason to cause the twinkle problem. In the present disclosure, a section of low-level signals are at least outputted in one transparent cycle of each lens. In this way, the luminous flux waveform in the present disclosure further deviates from a sine curve compared to the luminous flux waveform in the prior art at 60 Hz frequency. After applying the Fourier transform, a time domain waveform of the luminous flux waveform is transformed into a frequency domain waveform of the luminous flux waveform. The part of the time domain waveform that deviates from the sine curve is fitted using a high frequency part in Fourier fitting. Due to the delayed effect of the LCs, a frequency spectrum waveform of the luminous flux curve forms more waveforms at higher frequencies. As the frequency of shutdown increases, energy distributed at higher frequency also increases, and the frequency hand distributed on the waveform becomes higher. As the frequency band on the frequency spectrum becomes higher, the more difficult the generation of the twinkle by the human eyes becomes. Therefore, the present disclosure can effectively improve the twinkle problem of the 3D shutter type glasses. In addition, the technical scheme can be easily matched with a time sequence of a backlight driver of the LCD (as shown in FIG. 3).

The present disclosure is further described in detail in accordance with the figures and the preferable examples.

As shown in FIG. 4, the low-level signal of the example is a shutdown level signal. The control module only outputs a section of shutdown level signals in one transparent cycle of each lens. A square wave f shows a driven waveform. A curve e shows the luminous flux waveform, namely the original luminous flux waveform is divided into two sections. The time domain waveform of the curve e is transformed into the frequency domain waveform. As shown in FIG. 5, curve g is a Fourier transform fitted curve of the curve e on the frequency spectrum. After the waveform is divided into two sections, the curve e deviates from the sine wave to a higher degree and the deformation degree is greater. Therefore, the number of the high order increases, the degree of the high order at 60 Hz frequency decreases and the degree of the high order at 120 Hz frequency increases. The frequency of shutdown is higher, the light loss of a display image is more, and the image is darker, if the lenses are closed once, the twinkle is reduced while the light loss of the display image is reduced to a minimum.

Corresponding to a one-time shutdown, the driving waveform outputted by the control module successively comprises a first high-level signal, a shutdown level signal, and a second high-level signal. A proportion of the shutdown level signal to an entire display cycle of one lens is between 1/7 and ⅕. Because the deflection of the LCs needs some time, the shutdown time may not be too short: otherwise the LCs may not deflect. Certainly, the shutdown time may not be too long; otherwise the light loss is too much, thus influencing the display effect. A study finds it is ideal that the proportion of the shutdown level signal to the entire display cycle of one lens is between 1/7 and ⅕. A proportion of the first high-level signal to the entire display cycle is between 2/7 and ⅖. After the output of the first high-level signal is finished, the LCs do not reach a required deflection position. At this moment. the lenses are closed and the light loss is smaller. Optionally, a proportion of the second high-level signals to the entire display cycle is between 2/7 and ⅖. Before the second high-level signal is outputted, the LCs almost reach the deflection position. At this moment, light rays of entering the glasses are strongest. Heretofore, the glasses are dosed, thus better reducing the twinkle.

As an exemplary scheme, the time proportion of the first high-level signal to the shutdown level signal to the second high-level signal is 2:1:3. In a study, by adopting the proportion of the example, contradiction between the reduction of the twinkle and the reduction of the light loss can be effectively balanced and the viewing effect can be improved.

Certainly, the glasses of the present disclosure can be closed twice or above in one display cycle. The typical luminous flux waveform in one transparent cycle is divided into three sections, four sections, or more. The frequency of closing is higher, the effect of eliminating the twinkle is better, but the loss of light transmissivity is more. The specified conditions are comprehensively considered according to different types and customer requirements.

The present disclosure is not limited to output the shutdown level signal. The control module only needs to output at least one section of low-level signals with lower voltage than voltage of the high-level signals.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A driving method of three-dimensional (3D) shutter type glasses, Wherein a kit lens of the 3D shutter type glasses is transparent in its transparent cycles and closed in its shutdown cycles, and a right, lens of the 3D shutter type glasses is transparent in its transparent cycles and closed in its shutdown cycles, wherein a driving circuit of the 3D shutter type glasses executes a step comprising:
A: only outputting a section of shutdown levels in one transparent cycle of each lens; wherein in a single transparent cycle, a first high-level signal is outputted before the shutdown level is outputted, and a second high-level signal is outputted after the shutdown level is outputted; and
herein in one transparent cycle of each lens, a proportion of durations of the shutdown level to the first high-level signal to the second high-level signal is 2:1:3.

2. A driving method of 3D shutter type glasses, wherein a left lens of the 3D shutter type glasses is transparent in its transparent cycles and dosed in its shutdown cycles, and a right lens of the 3D shutter type glasses is transparent in its transparent cycles and closed in its shutdown cycles, wherein a driving circuit of the 3D shutter type glasses executes to step comprising:
A: at least outputting a section of low-level signals in one transparent cycle of each lens.

3. The driving method of 3D shutter type glasses of claim 2, wherein the low-level signal is to shutdown level signal.

4. driving method of 3D shutter type glasses of claim 3, wherein in the step A, only a section of low-level signals are outputted in one transparent cycle of each lens; in a single transparent cycle, a first high-level signal is outputted before the low-level signal is outputted, and a second high-level signal is outputted after the low-level signal is outputted.

5. The driving method of 3D shutter type glasses of claim 4, wherein in the step A, a proportion of duration of the low-level signal to the transparent cycle is between 1/7 and ⅕.

6. The driving method of 3D shutter type glasses of claim 4, wherein in the step A, a proportion of duration of the first high-level signal before the low-level signal to the transparent cycle is between 2/7 and ⅖.

7. The driving method of 3D shutter type glasses of claim 4, wherein in the step A, a proportion of duration of the second high-level signal after the low-level signal to the transparent cycle is between 2/7 and ⅖.

8. The driving method of 3D shutter type glasses of claim 4, wherein in the step A, in one transparent cycle of each lens, a proportion of durations of the low-level signal to the first high-level signal to the second high-level signal is 2:1:3.

9. A driving circuit of three-dimensional (3D) shutter type glasses, comprising:
a control module for at least outputting a section of low-level signals in one transparent cycle of each lens of the 3D shutter type glasses.

10. The driving circuit of 3D shutter type glasses of claim 9, wherein a proportion of duration of the low-level signal outputted by the control module to a display cycle of one lens is between 1/7 and ⅕ in an entire display cycle of the one lens.

11. The driving circuit of 3D shutter type glasses of claim 9, wherein the control module successively outputs a first high-level signal, the low-level signal, and a second high-level signal in a display cycle of one lens; and a proportion of durations of the first high-level signal to the low-level signal to the second high-level signal is 2:1:3.
